(19) United States
(12) Patent Application Publication
(10) Pub. No.: US 2017/0063597 A1
(43) Pub. Date: Mar. 2, 2017

(54) API PROVIDER INSIGHTS COLLECTION

(71) Applicant: CA, Inc., New York, NY (US)

(72) Inventor: Ian KELLY, Colleyville, TX (US)

(73) Assignee: CA, Inc.

(21) Appl. No.: 14/840,896

(22) Filed: Aug. 31, 2015

(51) Int. Cl. H04L 12/24; H04L 29/06

(52) U.S. Cl. CPC H04L 41/046; H04L 67/42

(57) ABSTRACT

A method includes publishing, by a server, an application program interface (API). The method also includes deploying the published API and a helper agent to a client system. The helper agent is configured to bind to the published API on the client system and send a plurality of feedback metrics about the client system to the server. The plurality of feedback metrics indicate at least one use of the published API by the client system. The method also includes receiving, from the helper agent, the plurality of feedback metrics about the client system. The method further includes analyzing, using a processor, the plurality of feedback metrics about the client system.

### BACKGROUND

The disclosure relates generally to API providers, and more specifically to API provider insights collection.

### SUMMARY

According to one embodiment of the disclosure, a method includes publishing, by a server, an application program interface (API). The method also includes deploying the published API and a helper agent to a client system. The helper agent is configured to bind to the published API on the client system and send a plurality of feedback metrics about the client system to the server. The plurality of feedback metrics indicate at least one use of the published API by the client system. The method also includes receiving, from the helper agent, the plurality of feedback metrics about the client system. The method further includes analyzing, using a processor, the plurality of feedback metrics about the client system.

Other features and advantages of the present disclosure are apparent to persons of ordinary skill in the art in view of the following detailed description of the disclosure and the accompanying drawings.

### BRIEF DESCRIPTION OF THE DRAWINGS

For a more complete understanding of the configurations of the present disclosure, needs satisfied thereby, and the features and advantages thereof, reference now is made to the following description taken in connection with the accompanying drawings.

FIG. 1 illustrates a block diagram of a system for API provider insights collection in accordance with a non-limiting embodiment of the present disclosure.

FIG. 2 illustrates a flow chart of a method for API provider insights collection by a server and a helper agent configured to interact with the client system in accordance with a non-limiting embodiment of the present disclosure.

FIG. 3 illustrates a flow chart of a method of API provider insights collection in accordance with a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

An Application Programming Interface (API) is a set of classes and methods associated with a particular programming library, typically utilized to build a software application. In the context of web development, an API may be an HTTP, MQTT, or web socket based API. These APIs may be provided in multiple styles for interaction (e.g., REST, SOAP) where data is marshaled between a client application and the bound interface. APIs may be seen as building blocks that a developer may use to allow their system to interact with another. Internal APIs may be used exclusively within a company or organization to integrate systems. External APIs, on the other hand, may be primarily available to those outside of an organization or company, allowing those external consumers to interact with internal resources or programs.

APIs may provide the functionality for software applications to run smoothly and transparently on computer operating systems like Microsoft Windows® or Apple OS X, allowing consumers some of the same functionality they experience when using other applications on the same system. APIs may similarly provide for interaction between applications running on mobile or tablet technology. A web API—an API for a web browser or web server—may facilitate either server-side or client-side interaction.

Successful API management entails designing, publishing, and overseeing APIs in a manner that promotes scalability, security, and maximal uptime. Typically, after an API is published to consumers, for example a server publishes an API to multiple client systems, the server is unaware of how client systems actually use the API. For example, the server may be unaware of which classes or methods each client system calls and which it does not call. API product managers thus have very few metrics on how the consuming client applications at the code level.

Several solutions to this problem have been attempted, but none provide the ideal set of API-client system interaction data. For example, a developer may virtualize a service (i.e., create a mock service) that uses the API to imitate the API's interactions with the client system. In so doing, the developer may duplicate the capabilities of the API on the client system and record them, but the recorded data may be flawed—only the interactions during the recording may be analyzed and none before or after. As another example, the developer may model the client system's interaction with the API, but again the data is not ideal. Since real historical data is not being captured, there may be classes or functions used by real client systems that do not synch with those of the model, and any metrics on how client applications consume the API on a code level will be skewed.

As another example, the developer may analyze the engineering specification for how the API may interact with the client system (e.g., all classes, methods, objects, and protocols of the API that may be called by the client system). While this analysis of the API may yield all possible client interaction scenarios, this data is overinclusive, as it will include scenarios not actually used by any client system. Certain embodiments of the present disclosure provide tools to better inform API providers of accurate metrics on how client applications consumer the API.

In certain embodiments, a helper agent is deployed with a published API to the client system. The helper agent is configured to bind to the API on the client system and send feedback metrics about the client system's use of the published API back to the server. Once received, the server may analyze and use the metrics. In the case of a planned modification to the API, this may provide the advantage of allowing the developer to assess how many and in what manner client systems will be impacted by the planned modification. For example, in the above-described scenario, if the developer needs to modify the API in any way, he or she must re-publish the modified API and alert all consumers to upgrade to the new version. In certain embodiments of the present disclosure, however, the developer may use the client system data to see whether the client system actually uses the modified aspect of the API; if the client does not, then the developer need not alert the client system of the change.

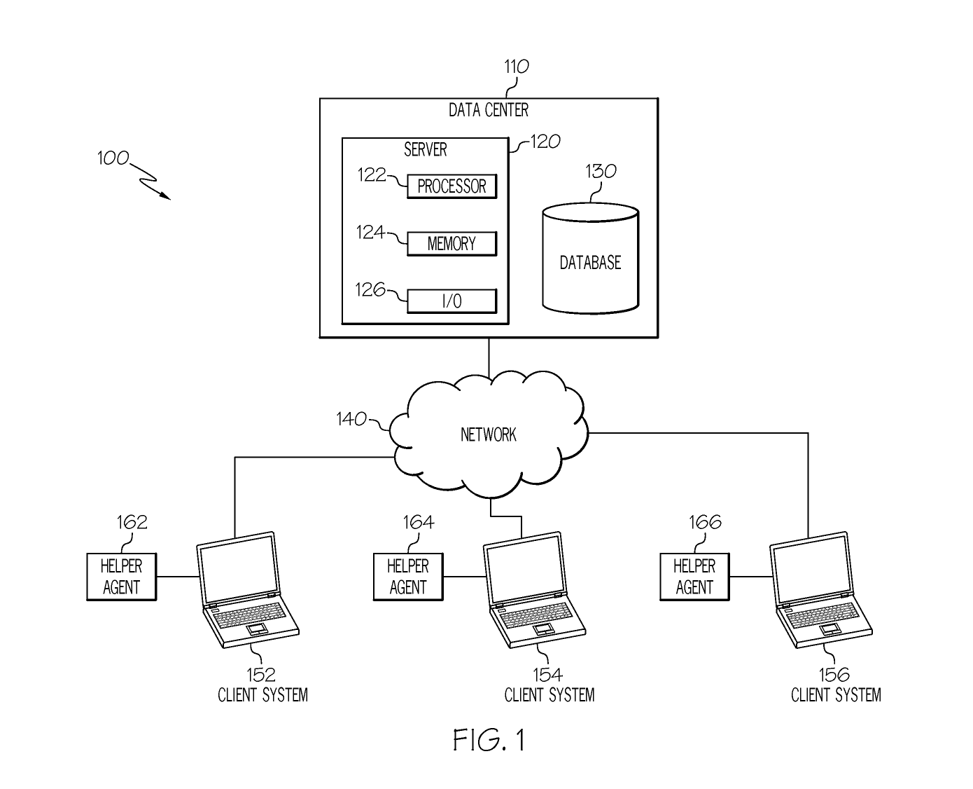

With reference to FIG. 1, a system 100 for API insights collection is illustrated in accordance with a non-limiting embodiment of the present disclosure. System 100 includes data center 110 and client systems 152, 154, and 156, which are all connected via network 140. Data center 100 contains a server 120 and a database 130. The server 120 contains a processor 122, a memory 124, and an I/O 126. For example, the processor 122 publishes an API over network 140 to client systems 152, 154, and 156. In certain embodiments of the present disclosure, helper agents 162, 164, and 166 are deployed with the published API over network 140 to client systems 152, 154, and 156 respectively. For example, helper agents 162, 164, and 166 may be downloaded by each respective client system as part of a software development kit (SDK) “helper kit” that offers simplified scaffolding and usage for an API. Helper agents 162, 164, and 166 are configured to bind to the published API on each of client systems 152, 154, and 156 respectively. For example, each of helper agents 162, 164, and 166 may create a feedback binding to the published API via a separate uniform resource identifier (URI).

Helper agents 162, 164, and 166 are also configured to send a plurality of feedback metrics about each of client systems 152, 154, and 156 respectively back to server 120. For example, once bound to separate URIs, each of helper agents 162, 164, and 166 may publish client details to the publisher API resource via those URIs. The plurality of feedback metrics indicate at least one use of the published API by each of client systems 152, 154, and 156. For example, the publish events may contain information about the applications being written on each of client systems 152, 154, and 156, including the fields being requested by the client, the casting of data to other structures, and the modifications of the values via augmentation or by re-organizing the data retrieved by the API. As another example, the feedback metrics may indicate the most used features of data sets within the API or operations on data being consumed via API. As yet another example, the feedback metrics may identify specific libraries and classes of the API providing methods and interfaces being consumed at the code level by each of client systems 152, 154, and 156. In certain other embodiments of the present disclosure, the plurality of feedback metrics may comprise performance or usage metrics about each of client systems 152, 154, or 156.

Server 120 receives the plurality of feedback metrics about client systems 152, 154, and 156 from each of helper agent 162, 164, and 166 respectively over network 140. Using processor 122, server 120 analyzes the plurality of feedback metrics about each of client system 152, 154, and 156. The details collected at the publisher may be used to analyze client interactions, for example to understand how each of client systems 152, 154, and 156 use the API, and why they use the API in that manner. By analyzing the feedback metrics on client systems 152, 154, and 156 in this manner, a developer may have more awareness, which may be used to better inform his or her API products or decisions. For example, without such awareness, a developer who tailors or modifies an API (e.g., adds or deletes a feature of the API) may need to alert all client systems 152, 154, and 156 and require each to upgrade to the new version, despite the modification not affecting certain client systems. In certain embodiments of the present disclosure, however, server 120, using processor 122, may analyze the feedback metrics received from client systems 152, 154, and 156 and determine that one or more client system does not use the modified feature of the API, for example client system 152. Server 120 may then publish the API and alert only the client systems which do use the modified feature (e.g., client systems 154 and 156), leaving client system 152 unalerted. Server 120 may thus publish the modified API without alerting a system administrator for client system 152 and without impacting client system 152. Server 120 may thus discriminate between what the client actually sees and uses and the features the client does not see or use. In this manner, certain embodiments of the present disclosure allow APIs to be modified while causing less impact to. Certain embodiments of the present disclosure may also be used in due diligence to better understand risk and gain competitive advantage.

As an example, server 120 may publish an API that contains classes and functions related to locating cars, including wide coverage of makes, models, and zip codes. Client system 152 may use the API in its application only to locate new cars within a specified zip code. Client system 154 may use the API in its application only to locate antique cars of a specified make and model. Thus, in certain embodiments of the present disclosure, if the developer deletes functionality related only to finding a particular antique make and model of car, then server 120 may analyze the feedback metrics received from client systems 152 and 154, and when the modified API publishes, only alert client system 154—not client system 152, which remains unaffected.

As another example, server 120 may publish an API that contains classes and functions that have the client systems import, for example, several thousand files from an external library. Using the helper agent, the developer may gain insight on how many external files the client systems actually use (e.g., only 150 external files) and identify how much of the library is leveraged. Using this information, the developer can streamline the API, making its use more efficient and scalable by adjusting the number of files the API requires client systems to download or import.

In certain embodiments of the present disclosure, server 120 generates a proposed modification to at least one feature of the published API. Based on the feedback metrics received from helper agents 162, 164, and/or 166, server 120 may determine that one or more of client systems 162, 164, and 166 does in fact use the feature or features of the API that server 120 proposes modifying. In response to determining that client system 152, 154, and/or 156 use the feature or features, server 120 may determine not to modify the published API and accordingly, not modify the published API. In other embodiments of the present disclosure, however, server 120 determines that one of client systems 162, 164, or 166 does use the feature or features of the API that server 120 proposes modifying, but also determines that the proposed modification to the API is of high priority. In response to determining that the proposed modification is high priority, server 120 may modify the at least one feature of the published API and alerts the system administrator of the client system that does use the modified feature or features of the API that the feature or features have been modified.

In another embodiment of the present disclosure, system 100 may be used to assess risk for deep dive touchpoints. For example, if any of client systems 152, 154, or 156 is running commercial software, that software may have defects or broad implications for potential compromise. In certain embodiments of the present disclose, the helper agent may be deployed to client system 152, 154, or 156, which uses this potentially defective commercial software, and the helper agent may inspect the classes, operations, and/or methods of the API being utilized by the commercial software. The developer may then accurately assess its risk in deploying to that client system and protect against that risk through specialized modification of the API.

In another embodiment of the present disclosure, the helper agent is configured to scan the code of the client system it is deployed to, for example client system 152, 154, or 156. The helper agent is configured to review code of the application being written on the client system, revealing the calls and dependencies to the API. In response to scanning the code, the helper agent may generate and return a certification report containing the list of libraries, classes, and/or APIs that are called and used by the client application. This certification report may be sent by the helper agent to server 120 to be analyzed. Also in response to scanning the code, the helper agent may also generate and return a dependency tree list of calls to the API. The helper agent may similarly send the dependency tree list of calls to server 120 for analysis.

In yet another embodiment of the present disclosure, the helper agent is configured to scan the client system application's source code for use of particular interfaces. If an interface is not used within the client system application's source code, for example, then the interface need not be virtualized; virtualization may be specified to the usage of the dependent components.

In certain embodiments of the present disclosure, server 120 saves the plurality of feedback metrics received from helper agent 162, 164, or 166 over network 140 into database 130 in data center 110. The plurality of feedback metrics may be saved with metadata associated with the client system to identify which client system they were associated with. As such, the feedback metrics may aggregate over time to form a bank of historical metrics. The feedback metrics may also be received by server 120 and saved into database 130 in real-time. In such embodiments, when server 120 analyzes the plurality of feedback metrics about the client system, for example to determine whether the client system utilizes a particular feature of the API, server 120 may access and retrieve all feedback metrics associated with the client system from the database and analyze and use those retrieved metrics. Server 120 may also run a specialized search to retrieve only a certain type of data from database 130, for example only data since the last modified API was released and updated on the client system.

In another embodiment of the present disclosure, server 120 may systematically poll one or more of helper agents 162, 164, and 166 for real-time feedback metrics about each respective client system. Helper agent 162, 164, and/or 166 is configured to then send a plurality of real-time feedback metrics about the client system to server 120 when the helper agent is polled. Systematic polling may take the form of pinging the helper agent at the time of a particular event, for example when the developer wishes to make a modification to the API, or in any continuous and systematic fashion (e.g. every 5 seconds, 5 minutes, 5 hours, or 5 days). The helper agent may instead be configured to send real-time feedback data back to server 120 in a continuous or systematic fashion without being polled.

In certain embodiments, the above-described features may be used only during the development and testing stages and removed before launch of the API. In other embodiments, the helper agent functionality may be used beyond the developing and testing stages, into and past launch of the API.

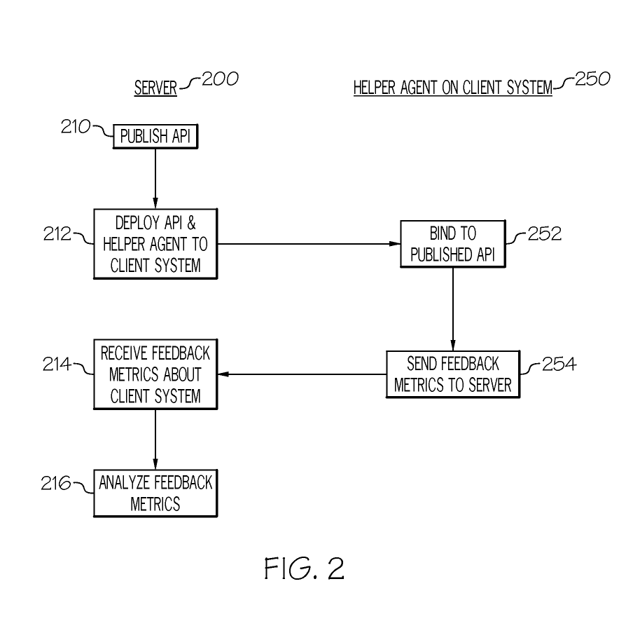

With reference to FIG. 2, a flow chart of steps used in API insights collection for a particular embodiment of the present disclosure is illustrated. At step 210, server 200 publishes the API. At step 212, server 200 deploys the API and helper agent to the client system. The helper agent on the client system 250 is configured to bind to the published API at 252 and send feedback metrics about the client system back to the server at 254. At step 214, server 200 receives feedback metrics about the client system, and at step 216, server 200 analyzes feedback metrics about the client system.

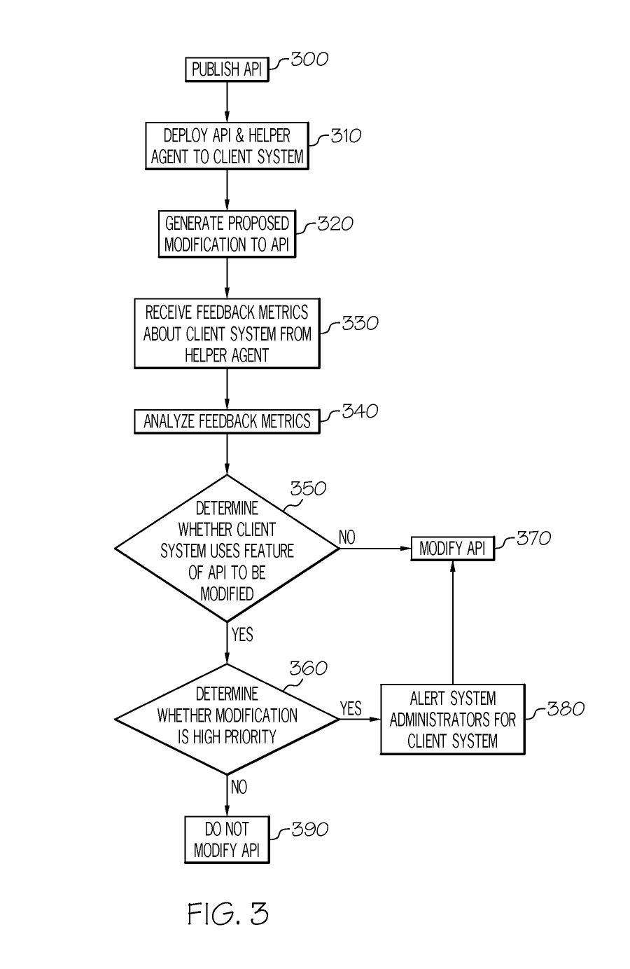

With reference to FIG. 3, a flow chart of steps used in API insights collection for a particular embodiment of the present disclosure is illustrated. At step 300, the server publishes the API. At step 310, the server deploys the API and helper agent to the client system. The helper agent is configured to bind to the API and send feedback metrics about the client system to the server. The feedback metrics indicate one or more uses by the client of the API, for example to create an application. At step 320, the server generates a proposed modification to the API. At step 330, the server receives feedback metrics about the client system from the helper agent on the client system. At step 340, the server analyzes the feedback metrics about the client system. At step 350, the server, using its processor, determines whether the client system uses the feature of the API that the server proposed modifying. If the client system does not use the feature of the API that was proposed to be modified, then at step 370, the server modifies the API, without alerting a system administrator for the client system and without causing impact to the client system. If, on the other hand, the client system does use the feature of the API that was proposed to be modified, then at step 360 the server, using its processor, may determine whether the modification was a high-priority modification. If the modification was not a high-priority modification, then at step 390 the server may not modify the API and not alert any client system administrators. But if the modification was a high-priority modification, then at step 380 the server may modify the API and alert the system administrator for the client system or systems that use the modified feature to upgrade to the modified version.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
publishing, by a server, an application program interface (API);
deploying the published API and a helper agent to a client system, wherein the helper agent is configured to:
bind to the published API on the client system; and
send a plurality of feedback metrics about the client system to the server, the plurality of feedback metrics indicating at least one use of the published API by the client system;
receiving, from the helper agent, the plurality of feedback metrics about the client system; and
analyzing, using a processor, the plurality of feedback metrics about the client system.

2. The method of claim 1, further comprising:
generating a proposed modification to at least one feature of the published API;
determining, based on the plurality of feedback metrics, that the client system does not use the at least one feature of the published API; and
in response to determining that the client system does not use the at least one feature of the published API, modifying the at least one feature of the published API without alerting a system administrator for the client system and without impacting the client system.

3. The method of claim 1, further comprising:
generating a proposed modification to at least one feature of the published API;
determining, based on the plurality of feedback metrics, that the client system uses the at least one feature of the published API; and
in response to determining that the client system uses the at least one feature of the published API:
determining not to modify the published API; and
not modifying the published API.

4. The method of claim 1, further comprising:
generating a proposed modification to at least one feature of the published API;
determining, based on the plurality of feedback metrics, that the client system uses the at least one feature of the published API;
determining that the proposed modification is high priority; and
in response to determining that the proposed modification is high priority:
modifying the at least one feature of the published API; and
alerting a system administrator for the client system that the at least one feature of the published API has been modified.

5. The method of claim 1, wherein the helper agent is further configured to:
scan an application on the client system associated with the published API; and
in response to scanning the application on the client system:
generate a certification report comprising at least one feature of the published API used in the application and a dependency tree list of the at least one feature of the published API used in the application; and
send the certification report and the dependency tree list to the server.

6. The method of claim 1, further comprising saving the plurality of feedback metrics in a database,
wherein analyzing the plurality of feedback metrics about the client system further comprises:
retrieving all feedback metrics associated with the client system from the database; and
analyzing the retrieved metrics.

7. The method of claim 1, further comprising systematically polling the helper agent for real-time feedback metrics about the client system,
wherein the helper agent is further configured to send a plurality of real-time feedback metrics about the client system to the server when the helper agent is polled.

8. A computer configured to access a storage device, the computer comprising:
a processor; and
a non-transitory, computer-readable storage medium storing computer-readable instructions that when executed by the processor cause the computer to perform:
publishing, by a server, an application program interface (API);
deploying the published API and a helper agent to a client system, wherein the helper agent is configured to:
bind to the published API on the client system; and
send a plurality of feedback metrics about the client system to the server, the plurality of feedback metrics indicating at least one use of the published API by the client system;
receiving, from the helper agent, the plurality of feedback metrics about the client system; and
analyzing, using the processor, the plurality of feedback metrics about the client system.

9. The computer of claim 8, wherein the computer-readable instructions further cause the computer to perform:
generating a proposed modification to at least one feature of the published API;
determining, based on the plurality of feedback metrics, that the client system does not use the at least one feature of the published API; and
in response to determining that the client system does not use the at least one feature of the published API, modifying the at least one feature of the published API without alerting a system administrator for the client system and without impacting the client system.

10. The computer of claim 8, wherein the computer-readable instructions further cause the computer to perform:
generating a proposed modification to at least one feature of the published API;
determining, based on the plurality of feedback metrics, that the client system uses the at least one feature of the published API; and
in response to determining that the client system uses the at least one feature of the published API:
determining not to modify the published API; and
not modifying the published API.

11. The computer of claim 8, wherein the computer-readable instructions further cause the computer to perform:
generating a proposed modification to at least one feature of the published API;
determining, based on the plurality of feedback metrics, that the client system uses the at least one feature of the published API;
determining that the proposed modification is high priority; and
in response to determining that the proposed modification is high priority:
modifying the at least one feature of the published API; and
alerting a system administrator for the client system that the at least one feature of the published API has been modified.

12. The computer of claim 8, wherein the helper agent is further configured to:
scan an application on the client system associated with the published API; and
in response to scanning the application on the client system:
generate a certification report comprising at least one feature of the published API used in the application and a dependency tree list of the at least one feature of the published API used in the application; and
send the certification report and the dependency tree list to the server.

13. The computer of claim 8, wherein the computer-readable instructions further cause the computer to perform saving the plurality of feedback metrics in a database,
wherein analyzing the plurality of feedback metrics about the client system further comprises:
retrieving all feedback metrics associated with the client system from the database; and
analyzing the retrieved metrics.

14. The computer of claim 8, wherein the computer-readable instructions further cause the computer to perform systematically polling the helper agent for real-time feedback metrics about the client system,
wherein the helper agent is further configured to send a plurality of real-time feedback metrics about the client system to the server when the helper agent is polled.

15. A computer program product comprising:
a computer-readable storage medium having computer-readable program code embodied therewith, the computer-readable program code comprising:
computer-readable program code configured to publish, by a server, an application program interface (API);
computer-readable program code configured to deploy the published API and a helper agent to a client system, wherein the helper agent is configured to:
bind to the published API on the client system; and
send a plurality of feedback metrics about the client system to the server, the plurality of feedback metrics indicating at least one use of the published API by the client system;
computer-readable program code configured to receive, from the helper agent, the plurality of feedback metrics about the client system; and
computer-readable program code configured to analyze, using a processor, the plurality of feedback metrics about the client system.

16. The computer program product of claim 15, wherein the computer-readable program code further comprises:
computer-readable program code configured to generate a proposed modification to at least one feature of the published API;
computer-readable program code configured to determine, based on the plurality of feedback metrics, that the client system does not use the at least one feature of the published API; and
computer-readable program code configured to, in response to determining that the client system does not use the at least one feature of the published API, modify the at least one feature of the published API without alerting a system administrator for the client system and without impacting the client system.

17. The computer program product of claim 15, wherein the computer-readable program code further comprises:
computer-readable program code configured to generate a proposed modification to at least one feature of the published API;
computer-readable program code configured to determine, based on the plurality of feedback metrics, that the client system uses the at least one feature of the published API; and
computer-readable program code configured to, in response to determining that the client system uses the at least one feature of the published API:
determine not to modify the published API; and
not modify the published API.

18. The computer program product of claim 15, wherein the computer-readable program code further comprises:
computer-readable program code configured to generate a proposed modification to at least one feature of the published API;
computer-readable program code configured to determine, based on the plurality of feedback metrics, that the client system uses the at least one feature of the published API;
computer-readable program code configured to determine that the proposed modification is high priority; and
computer-readable program code configured to, in response to determining that the proposed modification is high priority:
modify the at least one feature of the published API; and
alert a system administrator for the client system that the at least one feature of the published API has been modified.

19. The computer program product of claim 15, wherein the helper agent is further configured to:
scan an application on the client system associated with the published API; and
in response to scanning the application on the client system:
generate a certification report comprising at least one feature of the published API used in the application and a dependency tree list of the at least one feature of the published API used in the application; and
send the certification report and the dependency tree list to the server.

20. The computer program product of claim 15, wherein the computer-readable program code further comprises computer-readable program code configured to save the plurality of feedback metrics in a database,
wherein the computer-readable program code configured to analyze the plurality of feedback metrics about the client system further comprises:
computer-readable program code configured to retrieve all feedback metrics associated with the client system from the database; and
computer-readable program code configured to analyze the retrieved metrics.
